(19) United States
(12) Patent Application Publication
(10) Pub. No.: US 2011/0035694 A1
(43) Pub. Date: Feb. 10, 2011

(54) METHOD FOR BROWSING PHOTO FILES

(75) Inventors: TENG-YU TSAI, Tu-Cheng (TW); LIANG-MAO HUNG, Tu-Cheng (TW); CHIA-HUNG CHIEN, Tu-Cheng (TW); CHI-FAN HO, Tu-Cheng (TW); LING-WEI LIU, Tu-Cheng (TW); TIEN-PING LIU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/617,948

(22) Filed: Nov. 13, 2009

(30) Foreign Application Priority Data
Aug. 5, 2009 (CN) 200910305206.4

(51) Int. Cl. G06F 3/048

(52) U.S. Cl. 715/772; 715/838; 715/830

(57) ABSTRACT

A method for browsing photo files in an embedded electronic device includes the following steps. A user interface window is displayed on a display. The user interface window includes a navigator bar and a content display area for showing photos, and at least one control button is loaded on the navigator bar for executing control functions to the photos. The electronic device detects if an external storage device is connected to the electronic device. A new resource button linking to the external storage device is created on the navigator bar when the external storage device is connected. Thumbnail image of each photo file from the external storage device is displayed on the content display area.

### BACKGROUND

1. Technical Field

The disclosure generally relates to methods for browsing photo files in an embedded electronic device.

2. Description of Related Art

Embedded electronic devices, such as digital cameras, set-top boxes, digital phone frames, and others provide many functions, such as playing multimedia files, reading documents, and browsing websites. The electronic device can be operated to browse photo files through a user interface (UI). The photo files in the external storage devices connected to the electronic device must be selected from a resource folder.

### BRIEF DESCRIPTION OF THE DRAWINGS

FIG. 1 is a block view of an embedded electronic device according to an embodiment.

FIG. 2 is a flowchart of a method for displaying photo files in the embedded electronic device according an embodiment.

FIG. 3 is an embodiment showing a user interface showing photo files in a USB card.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM.

It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

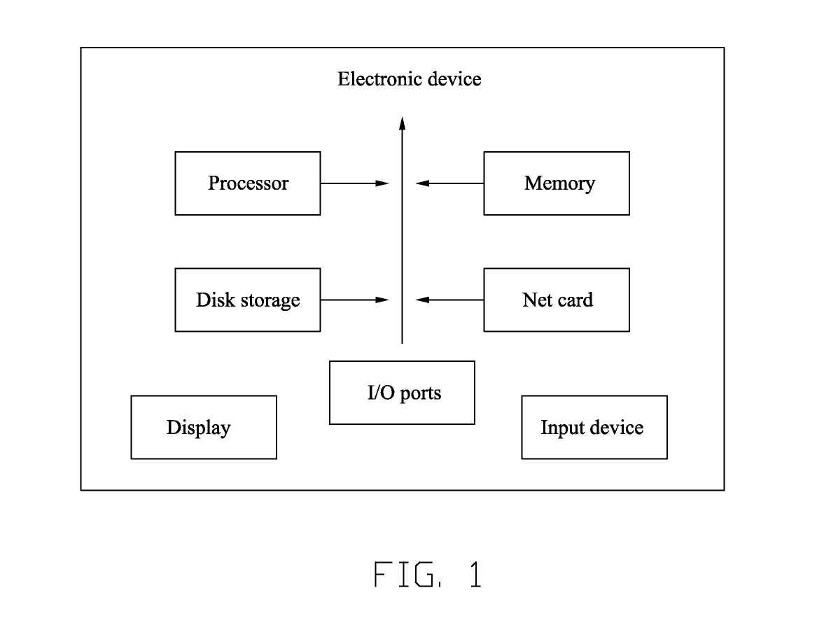

Referring to FIG. 1, an embedded electronic device includes a processor, a memory, a disk storage, a net card, input/output (I/O) ports, an input device and a display. The embedded electronic device has an embedded operation system such as embedded Linux operating system. A user interface (UI) is provided to manage photo files in the electronic device.

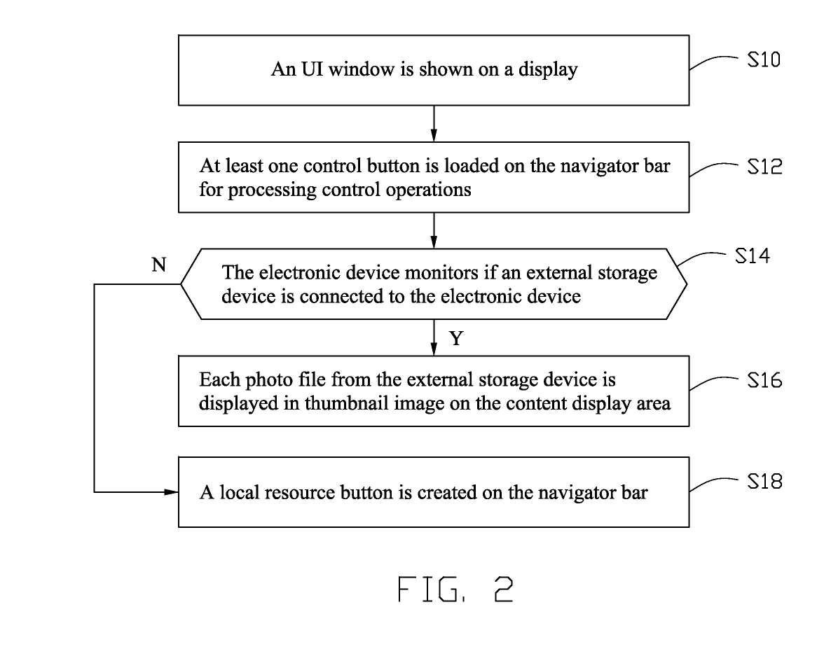

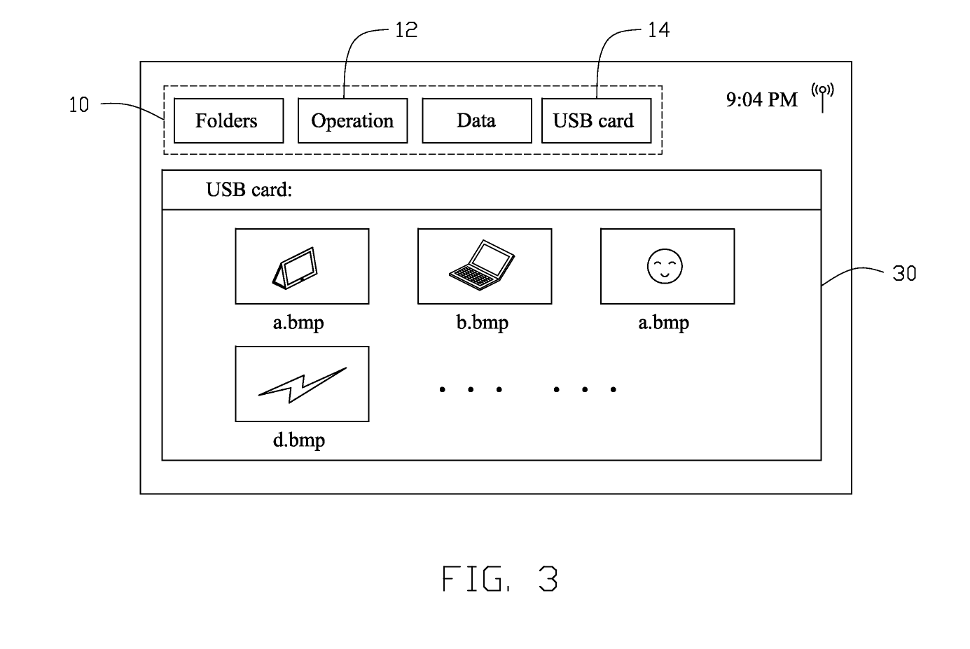

Referring to FIG. 2 and FIG. 3, a method for browsing photo files in the embedded electronic device according to the embodiment includes the following steps.

In step S10, an UI window is shown on a display, wherein the UI window includes a navigator bar 10 and a content display area 30 for showing photos. The navigator bar 10 and the content display area 30 are drawn based on extensible markup language. A dynamic progress window can be displayed to show a launching state of the UI window before creating the UI window on the display.

In step S12, at least one control button 12 is loaded on the navigator bar 10 for processing control operations.

In step S14, the electronic device detects if an external storage device is connected to the electronic device. A new resource button 14 linking to the external storage device is created on the navigator bar 10 when the external storage device is connected. The external storage device can be a compact flash (CF) card, a secure digital (SD) card, etc. When no external storage device is detected, the electronic device may create a local resource button on the navigator bar 10 to show local photos in the flash memory.

In step S16, each photo file from the external storage device is displayed in thumbnail image on the content display area. The thumbnail images are stored on a database in the external storage device. A scroll bar is loaded when the thumbnail images exceed display space.

When the UI window is shown, a monitor module can be loaded to the memory to monitor an orientation of the electronic device so as to automatically adjust a display direction of the UI. When at least one control action to the photos is performed on the control button 12, all the control actions are logged and the control operations may take into effect when the UI window is restarted.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the disclosure to the full extent indicated by the broad general meaning of the terms in which the appended claims are expressed.

Depending on the embodiment, certain of the steps described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A method for browsing photo files in an embedded electronic device comprising:
displaying a user interface window on a display, wherein the user interface window comprising a navigator bar and a content display area for showing photos;
loading at least one control button on the navigator bar capable of executing control functions to the photos;
detecting if an external storage device is connected to the electronic device, and creating a new resource button linking to the external storage device on the navigator bar when the external storage device is connected; and
displaying thumbnail image of each photo file from the external storage device on the content display area.

2. The method of claim 1 further comprising displaying a dynamic progress window to show a launching state of the user interface window before creating the user interface window on the display.

3. The method of claim 1, wherein the thumbnail images are stored in a database on the external storage device.

4. The method of claim 1, wherein a scroll bar is loaded when the thumbnail images exceed display space.

5. The method of claim 1 further comprising monitoring an orientation of the electronic device so as to automatically adjust a display direction of the user interface after the user interface window is shown.

6. The method of claim 1 further comprising logging control actions to the photos, and taking the control actions into effect when the UI window is restarted.

7. The method of claim 1, wherein the external storage device is a flash storage device.

8. The method of claim 1, wherein the navigator bar and the content display area are drawn based on extensible markup language.

9. The method of claim 1, wherein the electronic device has a Linux operating system.
